(19) United States
(12) Patent Application Publication
(10) Pub. No.: US 2021/0062995 A1
(43) Pub. Date: Mar. 4, 2021

(54) LIGHT SHIELD AND LAMP ASSEMBLY INCLUDING THE LIGHT SHIELD

(71) Applicant: TRIPLE WIN TECHNOLOGY(SHENZHEN) CO.LTD., Shenzhen (CN)

(72) Inventor: XIANG-DONG FANG, Shenzhen (CN)

(21) Appl. No.: 16/940,626

(22) Filed: Jul. 28, 2020

(30) Foreign Application Priority Data
Sep. 2, 2019 (CN) 201910824859.7

(51) Int. Cl. F21V 1/14

(52) U.S. Cl. CPC F21V 1/146; F21Y 2103/33

(57) ABSTRACT

A light shield for a ring light, to reduce abnormal images occurring because of errant and uncontrolled light entering an image-capturing module, includes a first shield portion, a second shield portion, and a third shield portion. The first shield portion is on an exterior of the light shield. The third shield portion is on an interior of the shield. The second shield portion is arranged between the first shield portion and the third shield portion and is inclined relative to the first and third shield portions. The light shield controls the direction of light emitted from the ring light, allowing an adjacent camera module or other image-capturing device to function normally and accurately. The disclosure further provides a lamp assembly including the light shield.

### FIELD

The subject matter herein generally relates to a light shield and a lamp assembly including the light shield.

### BACKGROUND

A ring light is widely used. However, the present ring light does not have a lamp cover, which enables emitted light to interfere with image-capturing equipment. This can be problematic in a quality control or manufacturing environment.

### BRIEF DESCRIPTION OF THE DRAWINGS

Implementations of the present technology will now be described, by way of embodiment, with reference to the attached figures.

FIG. 1 is an isometric view of an embodiment of a light shield.

FIG. 2 is a top view of the light shield of FIG. 1.

FIG. 3 is a front view of the light shield of FIG. 1.

FIG. 4 is a left view of the light shield of FIG. 1.

FIG. 5 is a schematic view of an embodiment of a lamp assembly.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

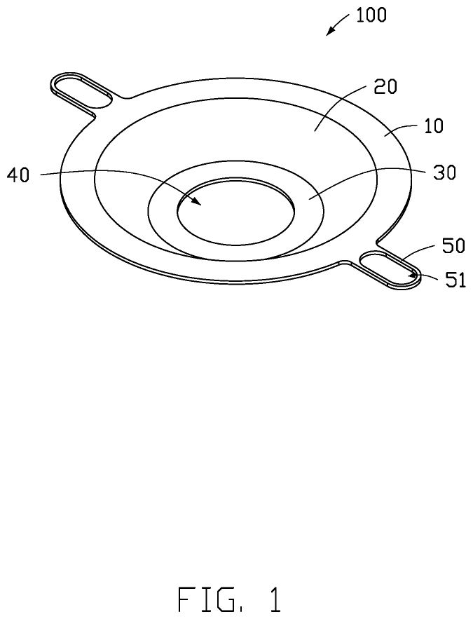

FIG. 1 illustrates an embodiment of a light shield 100. The light shield 100 is configured to apply controls to the light from a lamp, such as a ring light. The light shield 100 includes a first shield portion 10, a second shield portion 20, and a third shield portion 30. The second shield portion 20 connects the first shield portion 10 and the third shield portion 30. The first shield portion 10 is on an exterior of the light shield 100, the third shield portion 30 is on an interior of the light shield 100, and the second shield portion 20 is arranged between the first shield portion 10 and the third shield portion 30.

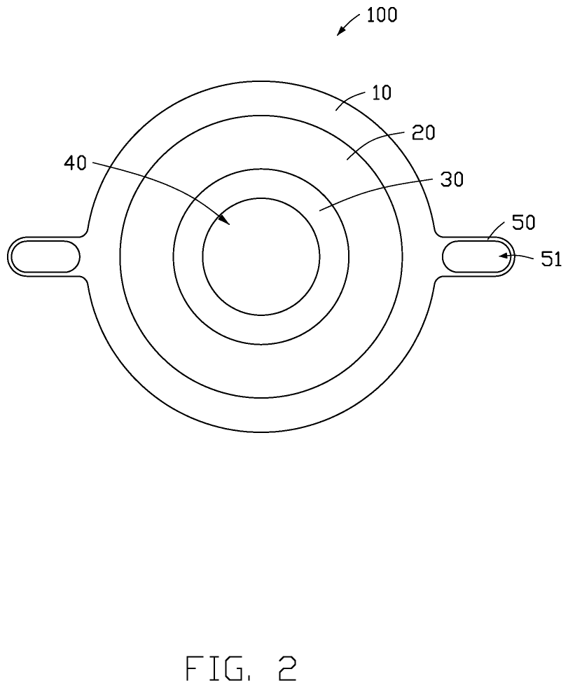

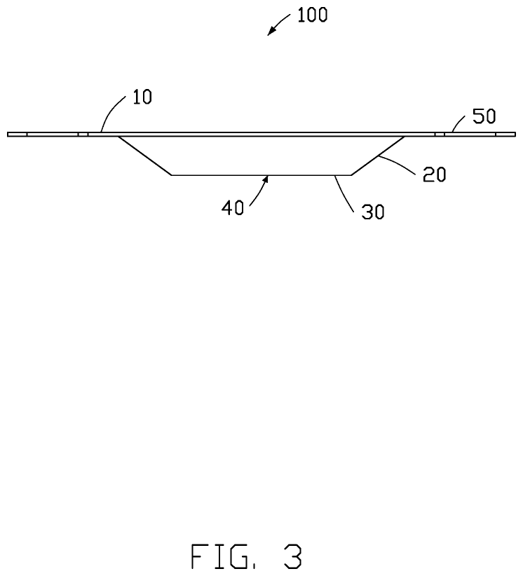

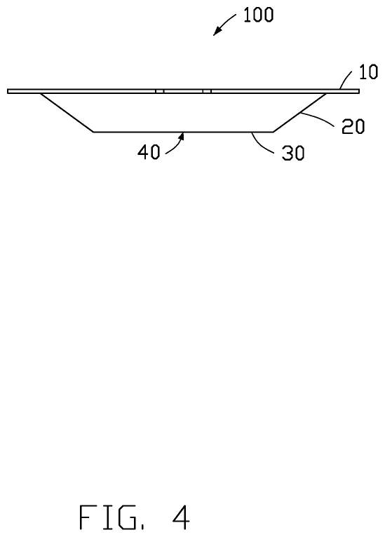

FIGS. 2 to 4 illustrate that respective diameters of the first, second, and third shield portions 10, 20, and 30 decrease in succession. In one embodiment, the first shield portion 10 is parallel to the third shield portion 30. The second shield portion 20 is inclined relative to the first shield portion 10 and the third shield portion 30.

The first shield portion 10, the second shield portion 20, and the third shield portion 30 are arranged along a common axis. The nearest distance between the third shield portion 30 and the axis is about 17 cm, the nearest distance between the second shield portion 20 and the axis is about 20 cm, the nearest distance between the first shield portion 10 and the axis is about 25 cm. The farthest distance between the first shield portion 10 and the axis is about 30 cm. A vertical distance between the first shield portion 10 and the third shield portion 30 is about 5.3 cm.

The light shield 100 further defines a through hole 40. The third shield portion 30 is arranged around the through hole 40. In one embodiment, a cross section of the through hole 40 is circular. The axis of the through hole 40 is the same as the axis of the first shield portion 10, the second shield portion 20, and the third shield portion 30. The diameter of the through hole 40 is equal to the nearest distance between the third shield portion 30 and the axis, which is about 17 cm.

The light shield 100 further includes at least one mounting portion 50. Each mounting portion 50 is arranged on the first shield portion 10. In one embodiment, the light shield 100 includes two mounting portions 50. The two mounting portions 50 are fixed on an edge of the first shield portion 10 away from the second shield portion 20. The two mounting portions 50 are opposite to each other. Each mounting portion 50 defines a fixing hole 51, the fixing hole 51 is a through hole. The fixing holes 51 can be threaded holes, that is, the hole wall of the fixing hole 51 is provided with thread. The light shield 100 is fixed by the fixing holes 51. A positional base (not shown) for the light shield 100 includes at least one fixing member which defines a mounting point or hole corresponding to each fixing hole 51 and is provided with a fastener. The fastener passes through the mounting hole and the fixing hole 51 to fasten the light shield 100 on the base. The mounting points or holes can be threaded and the fastener can be a screw or nut.

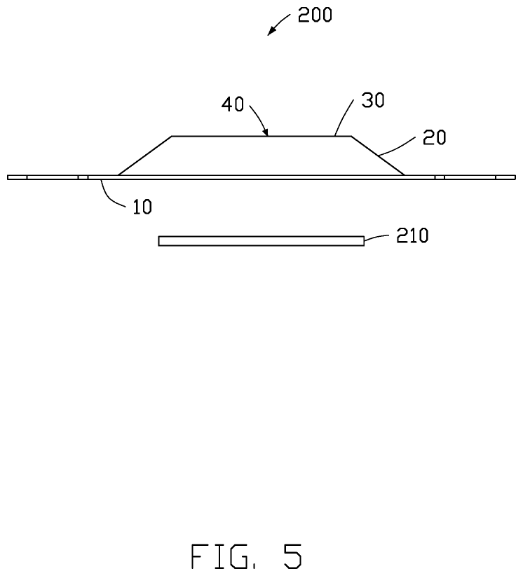

FIG. 5 illustrates an embodiment of a lamp assembly 200. The lamp assembly 200 includes the light shield 100 and a ring light 210. The light shield 100 covers the ring light 210. The ring light 210 substantially corresponds in size to the second shield portion 20, that is, light emitted upward from the ring light 210 is obstructed by the second shield portion 20. In one embodiment, the ring light 210 is arranged in the light shield 100, and the second shield portion 20 surrounds the ring light 210. The inclination of the second shield portion 20, relative to the first shield portion 10 and the third shield portion 30, means that light emitted upward (towards the second shield portion 20) from the ring light 210 is obstructed. Thus, light emitted from the ring light 210 does not cause interference to a camera module adjacent to the ring light 210.

Thus, the camera module can capture images without distortion and without being blinded, and false alarms because of abnormal image-capturing are eliminated, production efficiency can be improved.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A light shield comprising
a first shield portion on an exterior of the light shield;
a third shield portion on an interior of the light shield; and
a second shield portion arranged between the first shield portion and the third shield portion;
wherein the second shield portion is inclined relative to the first shield portion and the third shield portion.

2. The light shield of claim 1, wherein the first shield portion is parallel to the third shield portion.

3. The light shield of claim 1, wherein respective diameters of the first shield portion, the second shield portion, and the third shield portion decrease in succession.

4. The light shield of claim 1, wherein the light shield defines a through hole around which the third shield portion is arranged.

5. The light shield of claim 1, wherein the light shield further comprises at least one mounting portion, each of the at least one mounting portion is arranged on the first shield portion.

6. The light shield of claim 5, wherein each of the at least one mounting portion is arranged on an edge of the first shield portion away from the second shield portion, each of the at least one mounting portion defines a fixing hole.

7. The light shield of claim 1, wherein the first shield portion, the second shield portion, and the third shield portion are arranged along a common axis, the nearest distance between the third shield portion and the axis is 17 cm, the nearest distance between the second shield portion and the axis is 20 cm, the nearest distance between the first shield portion and the axis is 25 cm, the farthest distance between the first shield portion and the axis is 30 cm.

8. The light shield of claim 1, wherein a vertical distance between the first shield portion and the third shield portion is 5.3 cm.

9. A lamp assembly comprising:
a light shield comprising:
a first shield portion on an exterior of the light shield,
a third shield portion on an interior of the light shield, and
a second shield portion arranged between the first shield portion and the third shield portion; and
a ring light arranged in the light shield;
wherein the second shield portion is inclined relative to the first shield portion and the third shield portion, the second shield portion surrounds the ring light.

10. The lamp assembly of claim 9, wherein the first shield portion is parallel to the third shield portion.

11. The lamp assembly of claim 9, wherein respective diameters of the first shield portion, the second shield portion, and the third shield portion decrease in succession.

12. The lamp assembly of claim 9, wherein the light shield defines a through hole around which the third shield portion is arranged.

13. The lamp assembly of claim 9, wherein the light shield further comprises at least one mounting portion, each of the at least one mounting portion is arranged on the first shield portion.

14. The lamp assembly of claim 13, wherein each of the at least one mounting portion is arranged on an edge of the first shield portion away from the second shield portion, each of the at least one mounting portion defines a fixing hole.

15. The lamp assembly of claim 9, wherein the first shield portion, the second shield portion, and the third shield portion are arranged along a common axis, the nearest distance between the third shield portion and the axis is 17 cm, the nearest distance between the second shield portion and the axis is 20 cm, the nearest distance between the first shield portion and the axis is 25 cm, the farthest distance between the first shield portion and the axis is 30 cm.

16. The lamp assembly of claim 9, wherein a vertical distance between the first shield portion and the third shield portion is 5.3 cm.
